(19) United States
(12) Patent Application Publication
(10) Pub. No.: US 2015/0133099 A1
(43) Pub. Date: May 14, 2015

(54) MIGRATION OF A VIRTUAL ACCESS POINT

(71) Applicant: Hangzhou H3C Technologies Co., Ltd., Hangzhou, Zhejiang (CN)

(72) Inventors: Guoxiang Xu, Beijing (CN); Haitao Zhang, Beijing (CN)

(21) Appl. No.: 14/395,373

(22) PCT Filed: Mar. 6, 2013
(86) PCT No.: PCT/CN2013/072225

§ 371 Date: Oct. 17, 2014

(30) Foreign Application Priority Data
Jun. 18, 2012 (CN) 201210203541.5

(51) Int. Cl. H04W 24/02; H04W 28/08; H04W 24/08

(52) U.S. Cl. CPC H04W 24/02; H04W 24/08; H04W 28/08
USPC 455/418

(57) ABSTRACT

A microcell wireless network includes at least one access controller (AC) and multiple physical APs in wireless communication with mobile stations. The AC configures an independent virtual AP for each mobile station in the microcell wireless network on a first physical AP associated with the mobile station. When migration of a virtual AP configured for a mobile station is required, the AC transferring the virtual AP from the first physical AP to a second physical AP according to a predetermined policy.

### BACKGROUND

In a wireless network, a mobile station (STA) may associate with an access point (AP) that provides communication services, such as connecting to the Internet. Each AP has a coverage area to support connection of multiple mobile stations within its area.

### BRIEF DESCRIPTION OF DRAWINGS

Non-limiting example(s) will be described with reference to the following, in which:

FIG. 1 is a block diagram of an example microcell wireless network according to the present disclosure;

FIG. 2 is a flowchart of an example method according to the present disclosure;

FIG. 3 is a detailed flowchart of a process for transferring a virtual AP according to block 220 in FIG. 2; and

FIG. 4 is a block diagram of an example structure of a network device capable of acting as an access controller in FIG. 1.

### DETAILED DESCRIPTION

The present disclosure provides a method and a device for centralized control and multi-channel deployment of multiple APs in a microcell wireless network. The microcell wireless network includes at least one access controller (AC) and multiple APs in communication with mobile stations. In one example, the AC configures an independent virtual AP for each mobile station in the network on a physical AP (“first physical AP”) associated with the mobile station. When migration of the virtual AP is required, the AC transfers the virtual AP from the first physical AP to another physical AP (“second physical AP”).

By virtualizing a separate AP for each mobile station, a separate virtual cell is configured for each mobile station in the microcell wireless network. The AC determines, in a centralized manner, a physical AP on which a virtual AP is configured for a mobile station. The virtual AP is migrated by the AC when required, for example to facilitate seamless roaming of the associated mobile station and load balancing among the physical APs in the microcell wireless network.

Throughout this disclosure, the terms “microcell wireless network” and “microcell network” generally refer to a network in which an AC is in communication with multiple physical APs, and neighbouring APs are deployed on different channels (e.g. different radio frequency channels). Deploying neighbouring APs on different channels reduces mutual interference among the APs in the network.

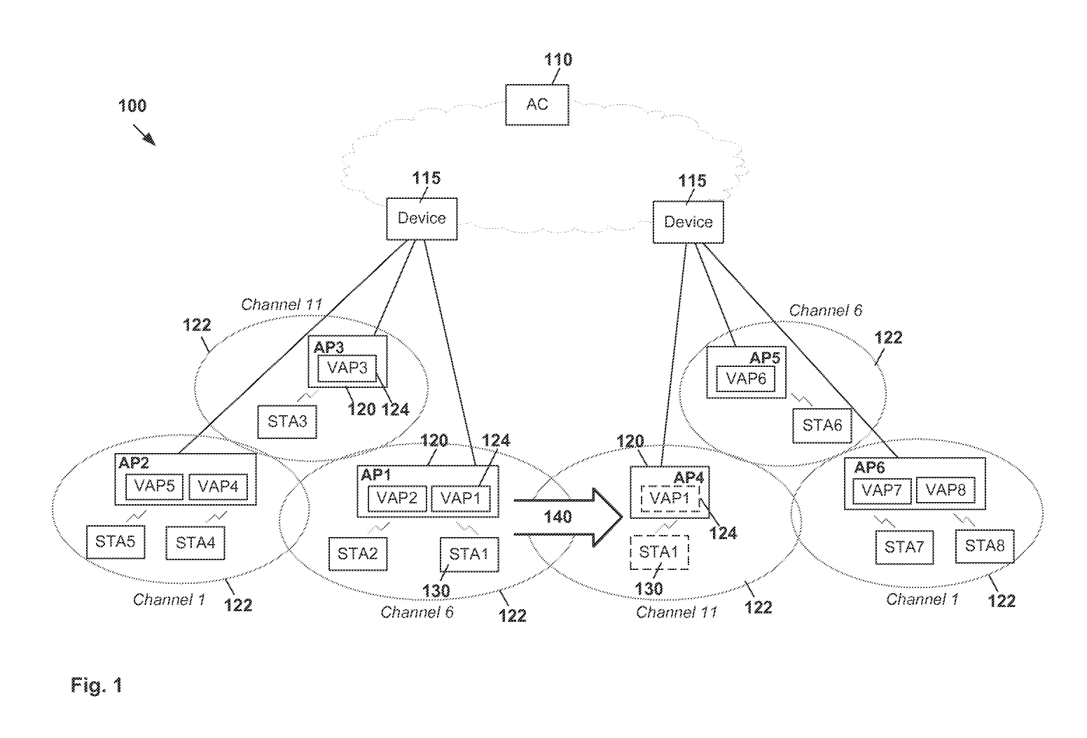

Non-limiting examples will now be discussed with reference to the drawings. FIG. 1 is a block diagram of an example microcell wireless network 100 which includes an AC 110, and multiple physical APs 120 (AP1, AP2, AP3, AP4, AP5, AP6) in communication with multiple mobile stations 130 (STA1, STA2, STA3, STA4, STA5, STA6, STA7, STA8). In the example in FIG. 1, the AC 110 is connected to the APs 120 via an intermediate network device 115 such as a switch, router etc. Although not shown in FIG. 1 for simplicity, it will be appreciated that the AC 110 may connect with any of the APs 120 directly.

The AC 110 manages the APs 120 in a centralized manner for the purposes of control, deployment, configuration, monitoring, and security etc. In the microcell wireless network 100, the AC 110 is in communication with multiple physical APs 120, and neighbouring APs 120 are deployed on different channels. For example, physical AP AP1 is deployed on radio frequency channel 6, and neighbouring AP2 on channel 1, and AP3 and AP4 (not direct neighbours) are on channel 11.

Each physical AP 120 has its own coverage or hot spot area 122, and a mobile station within its coverage area is said to be associated with the physical AP 120. For example, STA1 and STA2 are within the coverage area of AP1. The coverage area 122 of one physical AP (e.g. AP1) may or may not be overlapped with that of a neighbouring physical AP (e.g. AP4).

Since neighbouring APs 120 are deployed on different channels, the physical APs 120 are each able to receive and send packets independently. As such, the sending and receiving operations generally do not require any complex transmission scheduling at the AC 110. This reduces the processing load on the AC 110 and avoids the processing delay which is associated with centralized scheduling. Network throughput may also be higher compared to a network in which only a single channel is used. Further, in some implementations, the AC 110 is able to adjust the channels used by the physical APs 120 dynamically; this dynamic adjustment of channels provides a self-healing ability that may help to reduce service disruptions.

An AC 110 is generally a transceiver (transmitter and receiver) device that communicates with one or more remote nodes. An AP 120 may include a wireless base station, and the terms “access point” and “wireless base station” will be used interchangeably throughout the description. A mobile station 130 may be any suitable wireless device associated with an AP 120 to obtain network services, such as a mobile wireless device, laptop computer, tablet computer, desktop computer, and other computing devices etc.

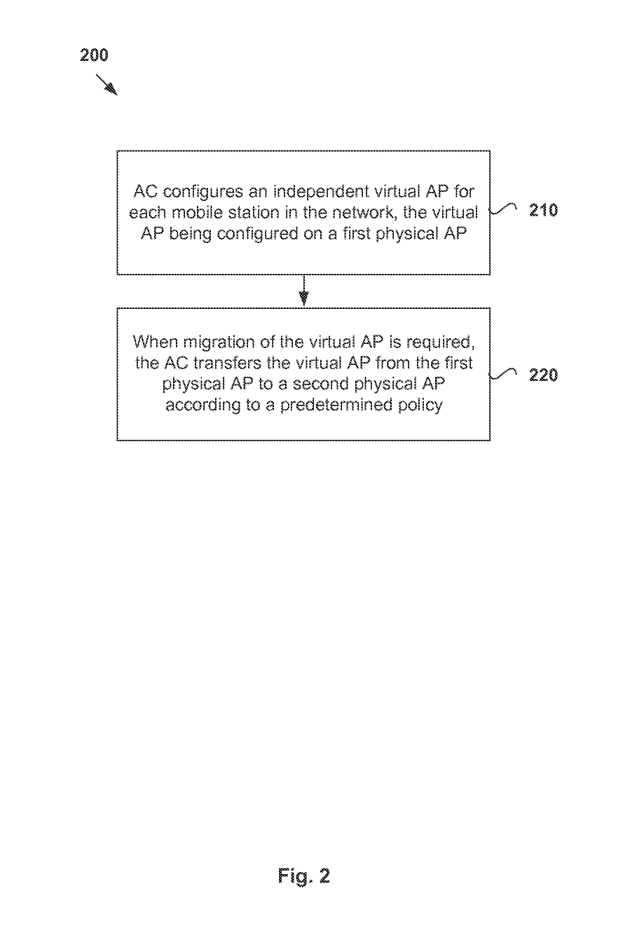

Referring also to FIG. 2, an example method 200 for centralized control and multi-channel deployment of APs 120 in the microcell wireless network 100 is provided, in which:
At block 210, the AC 110 configures an independent virtual AP 124 for each mobile station 130 in the network. The virtual AP 124 is configured on a first physical AP 120 associated with the mobile station 130. In the example in FIG. 1, mobile stations STA1 and STA2 are associated with a first physical AP 120, i.e. AP1. The AC 110 configures virtual APs VAP1′ and VAP2′ on AP1 for STA1 and STA2, respectively. Similarly, the AC 110 configures virtual AP VAP3′ to VAP8′ for mobile stations STA3 to STA8 respectively on various physical APs 120 (i.e. AP2 to AP6).
At block 220, when migration of a virtual AP 124 is required, the AC 110 transfers the virtual AP 124 from the first physical AP to a second physical AP according to a predetermined policy. As indicated at 140 in the example in FIG. 1, the AC 110 transfers virtual AP VAP1′ from AP1 to a different physical AP, i.e. AP4. From the perspective of mobile station STA1, it is still connected to the same virtual AP, i.e. VAP1′.

Non-limiting examples for blocks 210 and 220 will be described in more detail below.

### Virtual AP Configuration 210

According to block 210 in FIG. 2, the AC 110 configures an independent virtual AP 124 for each mobile station 130 on a physical AP 120 associated with the mobile station (“first physical AP”).

In one example, the configuration includes the AC 110 configuring a different identifier for each virtual AP 124. The virtual AP identifier may be in the form of a BSSID (Basic Service Set Identifier) etc. The BSSID is an identifier of wireless service provided by a single AP 120 and can be used to distinguish the same wireless service provided by different APs 120. As such, different virtual APs 124 will have different BSSIDs.

The configuration process also includes installing the virtual AP 124 on the physical AP 120. As shown in FIG. 1, more than one virtual AP 124 may be installed on a single physical AP 120, such as VAP1 and VAP2′ on AP1 and VAP4′ and VAP5′ on AP2. Since neighbouring AP1 and AP2 are deployed on different channels, they can receive and send messages independently, and the channels can be adjusted independently. This independent sending and receiving ability of the APs may relieve burden on the AC and the ability to adjust the channels used by the physical APs may provide a healing ability for the network in case a particular channel is disrupted.

Once installed, the physical AP 120 uses the virtual AP identifier (e.g. BSSID) provided by the AC 110 to perform various AP-related functions for the associated mobile station 130, such as transmission of beacon frames and data packets etc. Beacon frames are generally advertising frames that are broadcasted for various purposes, such as to inform mobile stations of the services provided by the AP 120. A beacon frame may contain service capability information, encryption information and service parameters etc.

### Virtual AP Migration 220

According to block 220 in FIG. 2, when migration of a virtual AP 124 is required, the AC 110 causes the virtual AP 124 to be transferred from the first physical AP 120 to a second physical AP 120 according to a predetermined policy.

Using FIG. 1 as an example, AP1 is the first physical AP, and AP4 the second physical AP. The virtual AP 124 to be migrated is VAP1, which is associated with mobile station 130 STA1. See also 140 in FIG. 1.

Migration of the virtual AP 124 may be required in various circumstances. For example, when a mobile station 130 roams or moves around in the microcell wireless network 100, migration of the virtual AP 124 configured for the mobile station 130 may be required. In another example, migration of virtual APs 124 serves as a load balancing mechanism by the AC 110 to actively adjust the load of the APs 120 in the network 100 etc.

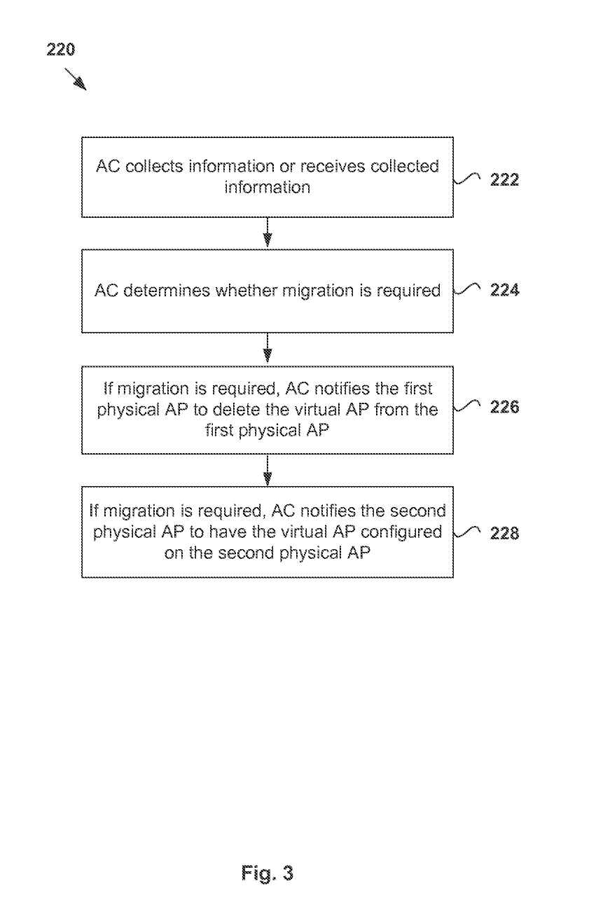

FIG. 3 is a detailed flowchart of an example process at block 220 in FIG. 2, which includes the following.

(i) At block 222 in FIG. 3, the AC 110 collects information or receives information collected by one or more physical APs 120 to determine whether migration is required. The information may be collected by one or more physical APs 120 via active listening or passive scanning, and then reported to the AC 110.

In the example in FIG. 1, one or more APs 120 (AP1 to AP6) collects the information and reports it to the AC 110. The information collected may be location information of the mobile stations 130, including any roaming mobile stations 130. Other information collected may include network information such as one or more of: transmission rate, retransmission ratio, number of frames that are successfully received, number of frames that are not successfully received, floor noise, interference condition, signal strength, average bandwidth used by each mobile station, number of mobile stations 130 connected to each physical AP 120, overall average channel utilization, etc.

(ii) At block 224 in FIG. 3, the AC 110 then determines whether migration is required according to a predetermined policy.
In one example, when a mobile station roams, the AC 110 uses the location information of the mobile station 130 to determine the most appropriate physical AP 120 for serving the mobile station 130. Using the example in FIG. 1, migration of the virtual AP VAP1 of mobile station STA1 is required when it moves from the coverage area of AP1 into that of AP4.
In another example, migration may be required for load balancing by the AC 110 in the microcell wireless network 100. In this case, the AC 110 assesses the load of each physical AP 120, based on the number of mobile stations 130 it serves. The AC 110 then determines whether it needs to adjust the load among the physical APs 120 based on the location information of the mobile stations, and/or network information.
Using the example in FIG. 1, if mobile station STA1 is within the coverage area 122 of both AP1 and AP4, the AC 110 might move virtual AP VAP1′ associated with STA1 to AP4 to reduce the load of AP1.

(iii) At block 226 in FIG. 3, if migration of a virtual AP 124 from a first physical AP 120 to a second physical AP 120 is required, the AC 110 first informs the first physical AP 120, such as by sending it a notification message. The AC 110 also informs the first physical AP 120 of the new channel where the second physical AP 120 is located.

The above causes the first physical AP 120 to send a Channel Switch Announcement frame to the mobile station 130. The ‘New Channel Number’ field in the frame is set to the channel to which the mobile station 130 is switching. The AP 120 then sends session information associated with the mobile station 130 to the AC 110, and deletes the virtual AP 124 configured for the mobile station 130. The session information may include a counter and a multicast key used in encryption and decryption etc.

In the example in FIG. 1, the AC 110 informs the first physical AP (i.e. AP1) of the transfer of VAP1 to the second physical AP (i.e. AP4), which is deployed on channel 11. AP1 then sends a Channel Switch Announcement frame to the mobile station 130 associated with VAP1, i.e. STA1. AP1 also sends session information of STA1 to the AC 110, and then proceeds to remove (or delete or uninstall) VAP1.

(iv) At block 226 in FIG. 3, the AC 110 sends a notification message the second physical AP 120. In particular, the AC 110 transfers information relating to the virtual AP 124 and associated mobile station 130 from the first physical AP 120 to the second physical AP 120. This includes the AC 110 sending the second physical AP 120 the virtual AP identifier (e.g. BSSID). It should be noted that the virtual AP identifier remains unchanged after the migration, which for example makes the migration easier and/or more seamless.

In addition, the AC 110 also sends the second physical AP 120 the session information received from the first physical AP 120, and security information of the mobile station 130. The security information is generally stored by the AC 110 and may include one or more of: multicast key, session key and shared key index.

The notification message from the AC 110 causes the second physical AP 120 to install the virtual AP 124 for the mobile station 130 based on the received BSSID of the virtual AP 124. Where appropriate, the relevant session and security information is also used. Once installed, the second physical AP 120 takes over the responsibilities of the first physical AP 120 to perform various functions of the virtual AP 124 for the mobile station 130, including receiving and sending data packets.

Using the example in FIG. 1 again, VAP1 is deleted from AP1 and installed on AP4 instead after the migration 140. The identifier of VAP1 (e.g. BSSID of VAP1) remains unchanged after the migration, and AP4 implements the functions of VAP1 using the session information and security information received. As such, the AC 110 supports seamless roaming of the mobile stations, as well as load balancing in the microcell wireless network.

In one implementation, if centralized packet forwarding is performed by the AC 110, the AC 110 stops forwarding packets to a particular mobile station 130 when its associated virtual AP 124 is being migrated to another physical AP 120. Instead, the AC 110 caches the packets. In the Channel Switch Announcement frame sent by the first physical AP 120 to the mobile station 130 at block 330, the field of ‘Channel Switch Mode’ will be set to zero, thereby causing the mobile station 130 to stop sending and receiving packets.

After the virtual AP 124 is installed at the second physical AP 120, the AC 110 will forward its cached traffic for the mobile station 130 to the second physical AP 120, such that the likelihood of packet loss for the mobile station 130 is reduced as much as possible.

### Network Device 110

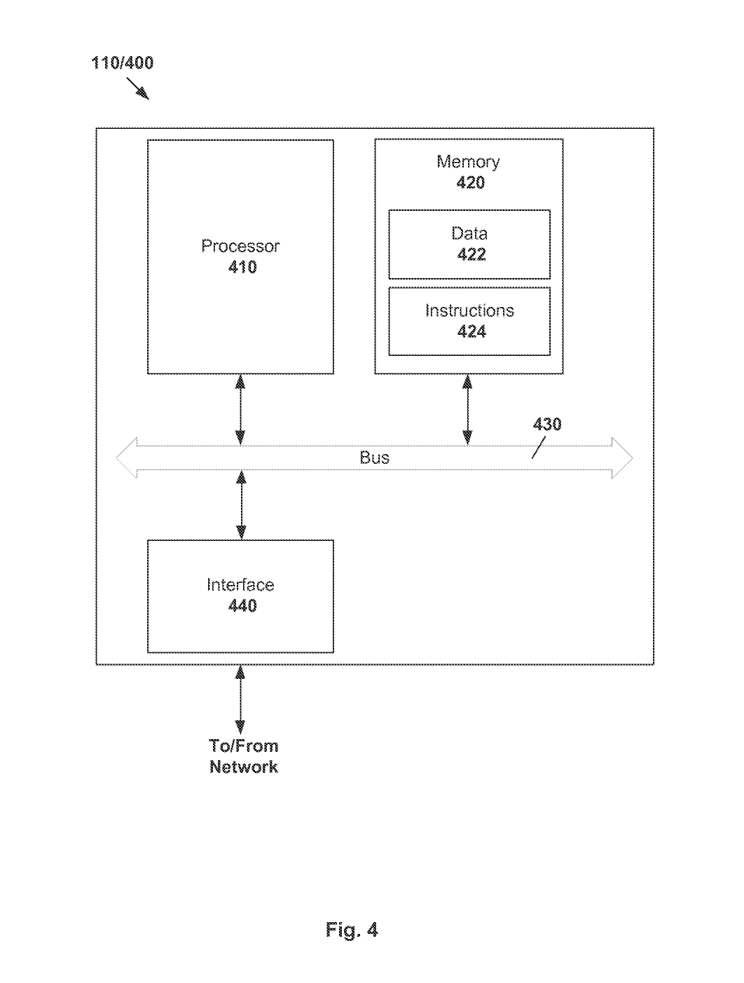

FIG. 4 shows a block diagram of an example network device capable of acting as an AC 110/400 for centralized control and multi-channel deployment of physical APs in a microcell wireless network.

The example network device 400 includes a processor 410; memory 420 storing necessary data 422 and machine-readable instructions 424; and network interface 440 that facilitates communication with the APs 120 in the network 110. The processor 410, memory 420 and interface 440 communicate with each other via a bus 430.

The processor 410 is to perform processes or operations described with reference to FIG. 2 and FIG. 3 in a microcell wireless network 100. In one example, the processor 410 is to:
configure an independent virtual AP 124 for each mobile station 130 in the microcell wireless network on a first physical AP 120 associated with the mobile station 130; and
when migration of a virtual VP 124 configured for a mobile station 130 is required, transfer the virtual AP 124 from the first physical AP 120 to a second physical AP 120 according to a predetermined policy.

In another example, the machine-readable instructions 424 may cause the processor 410 to implement one or more modules, such as:
a configuration module to configure an independent virtual AP 124 for each mobile station 130 in the microcell wireless network on a first physical AP 120 associated with the mobile station 130; and
a transfer module to, when migration of a virtual VP 124 configured for a mobile station 130 is required, transfer the virtual AP 124 from the first physical AP 120 to a second physical AP 120 according to a predetermined policy.

The machine-readable instructions 424 may further cause the processor 410 to implement an information collection module to collect information or receive collected information to determine whether migration is required; see examples in FIGS. 2 and 3.

The methods, processes and functional units described herein may be implemented by hardware (including hardware logic circuitry), software or firmware or a combination thereof. The term ‘processor’ is to be interpreted broadly to include a processing unit, ASIC, logic unit, or programmable gate array etc. The processes, methods and functional units may all be performed by the one or more processors 710; reference in this disclosure or the claims to a ‘processor’ should thus be interpreted to mean ‘one or more processors’.

Although one network interface device 440 is shown in FIG. 4, processes performed by the network interface device 440 may be split among multiple network interface devices (not shown for simplicity). As such, reference in this disclosure to a ‘network interface device’ should be interpreted to mean ‘one or more network interface devices”.

Further, the processes, methods and functional units described in this disclosure may be implemented in the form of a computer software product. The computer software product is stored in a storage medium and comprises a plurality of instructions for making a processor to implement the methods recited in the examples of the present disclosure.

The figures are only illustrations of an example, wherein the units or procedure shown in the figures are not necessarily essential for implementing the present disclosure. Those skilled in the art will understand that the units in the device in the example can be arranged in the device in the examples as described, or can be alternatively located in one or more devices different from that in the examples. The units in the examples described can be combined into one module or further divided into a plurality of sub-units.

Although the flowcharts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

It will be appreciated that numerous variations and/or modifications may be made to the processes, methods and functional units as shown in the examples without departing from the scope of the disclosure as broadly described. The examples are, therefore, to be considered in all respects as illustrative and not restrictive.

1. A method for centralized control and multi-channel deployment of physical access points (APs) in a microcell wireless network,
wherein the microcell wireless network includes at least one access controller (AC) and multiple physical APs in wireless communication with mobile stations, and neighbouring APs are deployed on different channels, the method comprising:
the AC configuring an independent virtual AP for each mobile station in the microcell wireless network on a first physical AP associated with the mobile station; and
when migration of a virtual AP configured for a mobile station is required, the AC transferring the virtual AP from the first physical AP to a second physical AP according to a predetermined policy.

2. The method of claim 1, wherein configuring an independent virtual AP for each mobile station comprises the AC configuring a different identifier for each virtual AP, and the identifier remains unchanged after the migration.

3. The method of claim 2, wherein the identifier configured for the virtual AP is a Basic Service Set Identifier (BSSID), and transferring the virtual AP from the first physical AP to the second physical AP comprises the AC sending, to the second physical AP, the BSSID of the virtual AP associated with the mobile station.

4. The method of claim 3, wherein transferring the virtual AP from the first physical AP to the second physical AP further comprises the AC sending, to the second physical AP, security information and/or session information of the mobile station associated with the virtual AP.

5. The method of claim 1, wherein transferring the virtual AP from the first physical AP to the second physical AP comprises causing a Channel Switch Announcement to be sent from the first physical AP to the mobile station associated with the virtual AP.

6. The method of claim 1, wherein migration of a virtual AP is required when the associated mobile station roams in the microcell wireless network, and/or when the AC performs load balancing to actively adjust the load of one or more APs in the microcell wireless network.

7. The method of claim 6, wherein the policy according to which the AC transfers the virtual AP associated with a roaming mobile station is predetermined based on location information of the mobile station.

8. The method of claim 6, wherein the predetermined policy according to which the AC transfers the virtual AP associated with a mobile station to perform load balancing is based on the number of mobile stations on each physical AP and/or channel parameters.

9. A device for centralized control and multi-channel deployment of physical access points (APs) in a microcell wireless network, wherein the device is capable of acting as an access controller (AC) and comprises a processor to:
configure an independent virtual AP for each mobile station in the microcell wireless network on a first physical AP associated with the mobile station; and
when migration of a virtual AP configured for a mobile station is required, transfer the virtual AP from the first physical AP to a second physical AP according to a predetermined policy.

10. The device of claim 9, wherein the processor is to configure an independent virtual AP for each mobile station comprises the AC configuring a different identifier for each virtual AP, and the identifier remains unchanged after the migration.

11. The device of claim 10, wherein the identifier configured for the virtual AP is a Basic Service Set Identifier (BSSID), and the processor is to transfer the virtual AP from the first physical AP to the second physical AP by sending, to the second physical AP, the BSSID of the virtual AP associated with the mobile station.

12. The device of claim 11, wherein the processor is to transfer the virtual AP from the first physical AP to the second physical AP by further sending, to the second physical AP, security information and/or session information of the mobile station associated with the virtual AP.

13. The device of claim 9, wherein the processor is to transfer the virtual AP from the first physical AP to the second physical AP by further causing a Channel Switch Announcement to be sent from the first physical AP to the mobile station associated with the virtual AP.

14. The device of claim 9, wherein migration of a virtual AP is required when the associated mobile station roams in the microcell wireless network, and/or when the device performs load balancing to actively adjust the load of one or more APs in the microcell wireless network.

15. The device of claim 14, wherein the predetermined policy according to which the processor transfers the virtual AP is based on one of:
location information of a mobile station roaming in the microcell wireless network; and
the number of mobile stations on each physical AP and/or channel parameters for load balancing in the microcell wireless network.
